(19) United States
(12) Patent Application Publication
(10) Pub. No.: US 2024/0333885 A1
(43) Pub. Date: Oct. 3, 2024

(54) PROJECTION METHOD, PROJECTION SYSTEM, AND PROJECTOR

(71) Applicant: SEIKO EPSON CORPORATION, Tokyo (JP)

(72) Inventor: Shuji OKANO, Oita-shi (JP)

(73) Assignee: SEIKO EPSON CORPORATION, Tokyo (JP)

(21) Appl. No.: 18/621,805

(22) Filed: Mar. 29, 2024

(30) Foreign Application Priority Data
Mar. 31, 2023 (JP) 2023-059303

(51) Int. Cl. H04N 9/31

(52) U.S. Cl. CPC H04N 9/3147; H04N 9/3179

(57) ABSTRACT

When a processing device has determined that a start request for display of a thumbnail image is accepted from a user, the processing device requests a second projector and a third projector to generate and transmit a thumbnail image. The processing device acquires a second thumbnail image generated by the second projector and a third thumbnail image generated by the third projector. The processing device generates a first thumbnail image. The processing device projects the first thumbnail image, the second thumbnail image, and the third thumbnail image adjacently to each other in a first projection area.

The present application is based on, and claims priority from JP Application Serial Number 2023-059303, filed Mar. 31, 2023, the disclosure of which is hereby incorporated by reference herein in its entirety.

### BACKGROUND

### 1. Technical Field

The present disclosure relates to a projection method, a projection system, and a projector.

### 2. Related Art

JP-A-2019-117989 discloses a multi-projection system where each projector projects a sub-image to a projection target.

However, in the technique according to JP-A-2019-117989, when a worker checks whether each sub-image is projected as intended by the worker or not, the worker may not be able to have an overview of the sub-images from one position, depending on the size, shape, arrangement or the like of the projection target. In such cases, the worker needs to move to a position where the worker can view the sub-images.

### SUMMARY

According to an aspect of the present disclosure, a projection method in a multi-projection system including a first projector and a second projector is provided. The projection method includes: in a first projection mode, projecting a first projection image based on an input image inputted to the first projector and the second projector, from the first projector into a first projection area, and projecting a second projection image based on the input image from the second projector into a second projection area; and in a second projection mode, projecting a first reduced image and a second reduced image adjacently to each other from the first projector into the first projection area. The first reduced image is a reduced image of the first projection image. The second reduced image is a reduced image of the second projection image.

According to another aspect of the present disclosure, a projection method in a multi-projection system including a first projector and a second projector is provided. The projection method includes: in a first projection mode, projecting a first projection image based on an input image inputted to the first projector and the second projector, from the first projector into a f projection area, and projecting a second projection image based on the input image from the second projector into a second projection area; and in a second projection mode, projecting at least one of a first reduced image and a second reduced image from the first projector into the first projection area. The first reduced image is a reduced image of the input image inputted to the first projector. The second reduced image is a reduced image of the input image inputted to the second projector.

According to still another aspect of the present disclosure, a projection method in a multi-projection system including a first projector and a second projector is provided. The projection method includes: in a first projection mode, projecting a first projection image from the first projector into a first projection area, and projecting a second projection image from the second projector into a second projection area; and in a second projection mode, projecting a first reduced image and a second reduced image adjacently to each other from the first projector into the first projection area. The first reduced image is a first captured image formed by picking up an image of the first projection area where the first projection image is projected. The second reduced image is a second captured image formed by picking up an image of the second projection area where the second projection image is projected.

According to still another aspect of the present disclosure, a projection system including a first projector and a second projector and performing multi-projection by the first projector and the second projector is provided. In a first projection mode, the first projector projects a first projection image into a first projection area. In the first projection mode, the second projector projects a second projection image into a second projection area. In a second projection mode, the first projector projects a first reduced image formed by reducing the first projection image and a second reduced image formed by reducing the second projection image, adjacently to each other in the first projection area.

According to still another aspect of the present disclosure, a projector included in a multi-projection system and comprising one or a plurality of processors. The one or plurality of processors are configured to: acquire an input image; acquire setting information that designates a content of image processing including at least cutting an image in a range to be projected into a first projection area, out of the input image; perform the image processing represented by the setting information to the input image and thus output a first projection image; generate a first reduced image formed by reducing the input image or the first projection image, from the input image or the first projection image; acquire a second reduced image generated based on a second projection image projected in a second projection area by another projector included in the multi-projection system. The projector is configured to perform: in a first projection mode, projecting the first projection image into the first projection area; and in a second projection mode, projecting the first reduced image and the second reduced image adjacently to each other in the first projection area.

### BRIEF DESCRIPTION OF THE DRAWINGS

FIG. 1 shows the configuration of a projection system according to a first embodiment.

FIG. 2 shows an example of an input image inputted to each projector.

FIG. 3 is a block diagram showing an example of the configuration of a master projector shown in FIG. 1.

FIG. 4 shows the relationship between posture information, posture setting information, and top-bottom direction of a thumbnail image.

FIG. 5 is a block diagram showing an example of the configuration of a data server shown in FIG. 1.

FIG. 6 shows an example of the operation of the projection system in a first projection mode.

FIG. 7 shows an example of the operation of the projection system in a second projection mode.

FIG. 8 shows an example of the operation of the projection system in the second projection mode.

FIG. 9 shows an example of the operation of the projection system in the second projection mode.

FIG. 10 is a flowchart showing an operation of displaying a thumbnail image by the processing device of the master projector.

FIG. 11 is a flowchart showing an operation of selecting a thumbnail image and changing settings, which is a subroutine of FIG. 10.

FIG. 12 shows the configuration of a projection system according to Modification Example 1.

### DESCRIPTION OF EMBODIMENTS

A preferred embodiment of the present disclosure will now be described with reference to the accompanying drawings. In the drawings, the dimension and scale of each part may differ from the actual dimension and scale and some parts are schematically shown in order to facilitate understanding. The scope of the present disclosure is not limited to the aspects of the embodiment unless any particular limitation to the present disclosure is given in the description below.

### 1. FIRST EMBODIMENT

### 1.1. Outline of Projection System

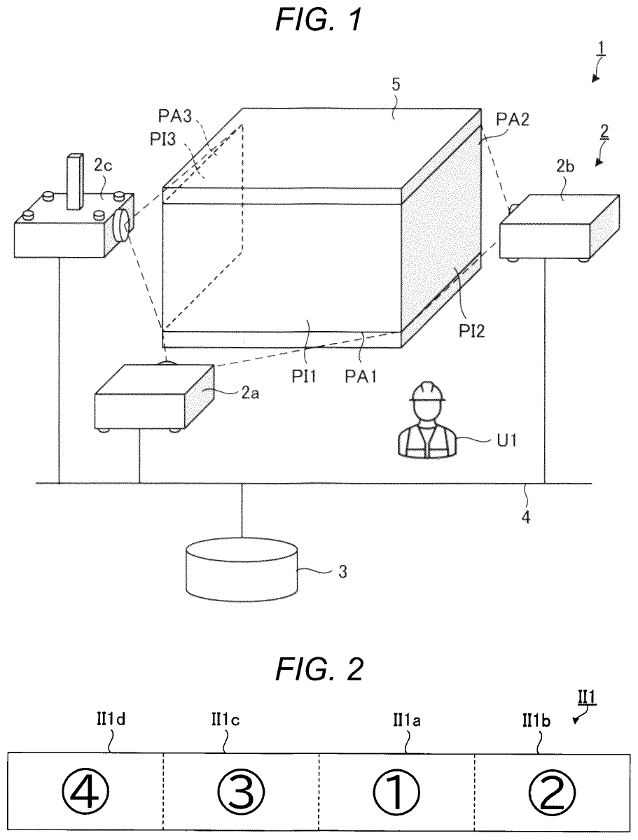

An outline of a projection system according to a first embodiment will now be described with reference to FIGS. 1 and 2.

FIG. 1 shows the configuration of the projection system according to the first embodiment. A projection system 1 includes a plurality of projectors 2 and a data server 3. The plurality of projectors 2 include a first projector 2a, a second projector 2b, and a third projector 2c.

The first projector 2a, the second projector 2b, the third projector 2c, and the data server 3 are connected to each other via a network 4. The network 4 is, for example, a LAN. LAN is an abbreviation for local area network. The LAN may be connected to the internet.

In the first embodiment, a projection target 5 is a pillar-like structure having four side faces. A first projection area PA1, a second projection area PA2, and a third projection area PA3 are provided at three side faces, respectively, of the four side faces of the projection target 5. The second projection area PA2 is disposed to the right of the first projection area PA1 and adjacently to the first projection area PA1. The third projection area PA3 is disposed to the left of the first projection area PA1 and adjacently to the first projection area PA1.

The first projector 2a projects a first projection image PI1 into the first projection area PA1. That is, the first projector 2a is disposed at a position where the first projector 2a can project the first projection image PI1 into the first projection area PA1. The first projector 2a is also disposed in such a way that the posture of the first projector 2a is a basic posture. The basic posture in this case refers to a normal posture in which the top and bottom of the main body of the first projector 2a are not reversed.

The second projector 2b projects a second projection image PI2 into the second projection area PA2. That is, the second projector 2b is disposed at a position where the second projector 2b can project the second projection image PI2 into the second projection area PA2. The posture of the second projector 2b is the basic posture, similarly to the posture of the first projector 2a.

The third projector 2c projects a third projection image PI3 into the third projection area PA3. That is, the third projector 2c is disposed at a position where the third projector 2c can project the third projection image PI3 into the third projection area PA3. The third projector 2c is also disposed in a so-called ceiling-hung state with the top and bottom reversed. The posture of the third projector 2c is an inverted posture with the top and bottom inverted, as opposed to the basic posture.

The data server 3 stores data of projection images to be projected by the first projector 2a, the second projector 2b, and the third projector 2c, respectively. The data server 3 transmits the stored data of the projection images to the first projector 2a, the second projector 2b, and the third projector 2c.

That is, the projection system 1 is a multi-projection system constructed using the three projectors 2 and the data server 3.

A user U1 is a worker carrying out the work of constructing the projection system 1. The user U1 operates the first projector 2a and thus decides a projector to participate in multi-projection. In this example, the first projector 2a used for the operation by the user U1 is a master projector in the projection system 1. The master projector manages all the projectors participating in this multi-projection.

The user U1 designates, for example, an address on the network 4 from among the projectors connected to the network 4 and thus selects a projector to participate in the multi-projection. In this example, the second projector 2b and the third projector 2c are the projectors selected by the user U1. Each of the second projector 2b and the third projector 2c selected by the user U1 is a slave projector. The slave projectors are managed by the master projector.

The user U1 operates the first projector 2a and thus can change various settings about the projection by the first projector 2a, the second projector 2b, and the third projector 2c. For example, when the first projector 2a requests the setting information of the second projector 2b from the second projector 2b, the second projector 2b transmits the second projector 2b's own setting information to the first projector 2a. When the first projector 2a requests the setting information of the third projector 2c from the third projector 2c, the third projector 2c transmits the third projector 2c's own setting information to the first projector 2a.

In this example, the first projector 2a is set to be the master projector and the second projector 2b and the third projector 2c are set to be the slave projectors. However, the embodiment is not limited to this example. For example, the second projector 2b may be set to be the master projector and the other projectors may be set to be the slave projectors. Also, the third projector 2c may be set to be the master projector and the other projectors may be set to be the slave projectors.

In the example shown in FIG. 1, the first projection area PA1 and the second projection area PA2 are in the field of vision of the user U1, whereas the third projection area PA3 is not in the field of vision of the user U1. That is, the third projection area PA3 is a blind area to the user U1. Therefore, in the circumstance shown in FIG. 1, the user U1 can view the first projection image PI1 and the second projection image PI2 but cannot view the third projection image PI3.

FIG. 2 shows an example of an input image inputted to each projector. An input image II1 is outputted from the data server 3 and inputted to each of the first projector 2a, the second projector 2b, and the third projector 2c via the network 4. That is, in this example, the same input image II1 is inputted to the first projector 2a, the second projector 2b, and the third projector 2c. In this example, one projection image based on the input image II1 is formed by the first projection image PI1 from the first projector 2a, the second projection image PI2 from the second projector 2b, and the third projection image PI3 from the third projector 2c.

The first projector 2a generates the first projection image PI1 from the inputted input image II1. The second projector 2b generates the second projection image PI2 from the inputted input image II1. The third projector 2c generates the third projection image PI3 from the inputted input image II1.

The user U1 plans to project a projection image corresponding to a first sub-image II1a, a projection image corresponding to a second sub-image II1b, and a projection image corresponding to a third sub-image II1c into the first projection area PA1, the second projection area PA2, and the third projection area PA3, respectively. The user U1 also plans not to use a fourth sub-image II1d in any projector, that is, not to project the fourth sub-image II1d from any projector.

### 1.2. Configuration of Projector

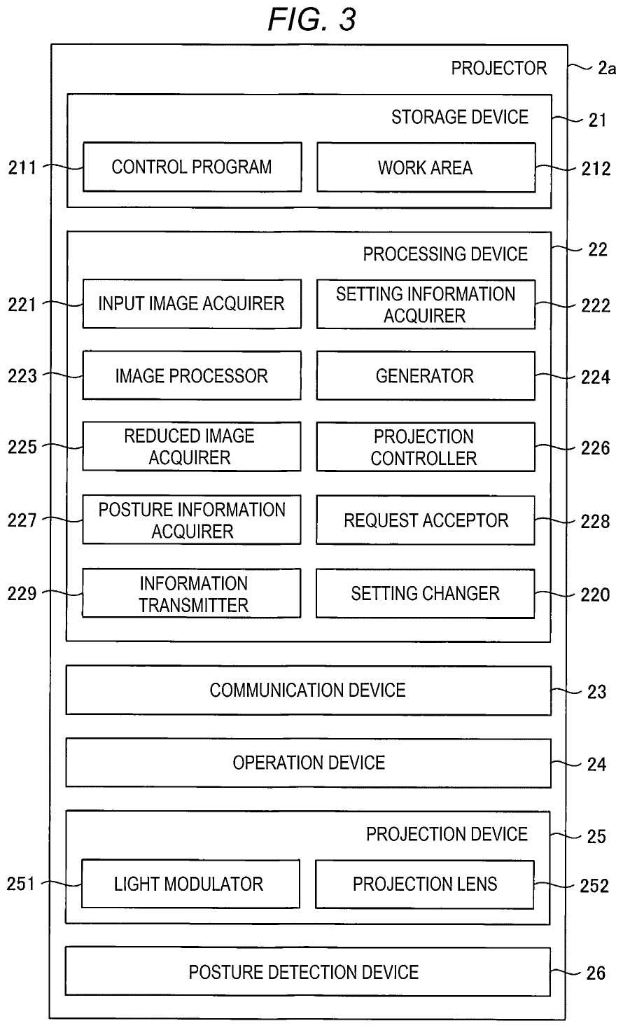

The configuration of the projector according to the first embodiment will now be described with reference to FIG. 3.

FIG. 3 is a block diagram showing an example of the configuration of the first projector 2a shown in FIG. 1. The first projector 2a has a storage device 21, a processing device 22, a communication device 23, an operation device 24, a projection device 25, and a posture detection device 26.

The storage device 21 stores various information. The storage device 21 is configured, for example, including a volatile memory such as a RAM and a non-volatile memory such as a ROM. RAM is an abbreviation for random-access memory. ROM is an abbreviation for read-only memory. A control program 211 or the like is stored in the storage device 21. The volatile memory of the storage device 21 is used by the processing device 22 as a work area 212 of the processing device 22. The control program 211 is a program that controls the entirety of the first projector 2a.

A part or the entirety of the storage device 21 may be provided in an external storage device, an external server, or the like. A part or all of the various information stored in the storage device 21 may be stored in the storage device 21 in advance or may be acquired from an external storage device, an external server, or the like.

The processing device 22 controls the operations of the first projector 2a. The processing device 22 has functions as an input image acquirer 221, a setting information acquirer 222, an image processor 223, a generator 224, a reduced image acquirer 225, a projection controller 226, a posture information acquirer 227, a request acceptor 228, an information transmitter 229, and a setting changer 220. The processing device 22 is configured, including one or more CPUs. However, the processing device 22 may have a programmable logic device such as an FPGA instead of or in addition to the CPU. CPU is an abbreviation for central processing unit. FPGA is an abbreviation for field-programmable gate array.

The processing device 22 reads out the control program 211 from the storage device 21 and executes the control program 211 thus read out. The processing device 22 executes the control program 211 and thus functions as the input image acquirer 221, the setting information acquirer 222, the image processor 223, the generator 224, the reduced image acquirer 225, the projection controller 226, the posture information acquirer 227, the request acceptor 228, the information transmitter 229, and the setting changer 220.

The input image acquirer 221 acquires the input image II1 via the communication device 23.

The setting information acquirer 222 acquires setting information of the first projector 2a. The setting information is information that designates a content of image processing including at least cutting an image in a range to be projected into the first projection area PA1, out of the input image II1.

The image processor 223 performs the image processing represented by the setting information to the input image II1 and thus outputs the first projection image PI1. The image processing includes processing such as cutting and luminance expansion. The cutting is the processing of cutting an image in a range to be projected into the first projection area PA1, out of the input image II1. The luminance expansion is the processing of adjusting the luminance of the first projection image PI1, based on a statistical quantity acquired by statistically processing the pixel values of all the pixels of the input image II1.

In other words, the first projection image PI1 is a first processed image formed by performing at least the processing of cutting a range to be projected into the first projection area PA1, out of the input image II1.

The generator 224 generates a first thumbnail image TI1 from the first projection image PI1. The first thumbnail image TI1 is a reduced image of the first projection image PI1. The generator 224 determines the top-bottom direction of the first thumbnail image TI1, based on posture information of the first projector 2a acquired by the posture information acquirer 227, and posture setting information. The posture setting information is information indicating which direction the top-bottom direction of the first projection image PI1 in the first projector 2a should be set to.

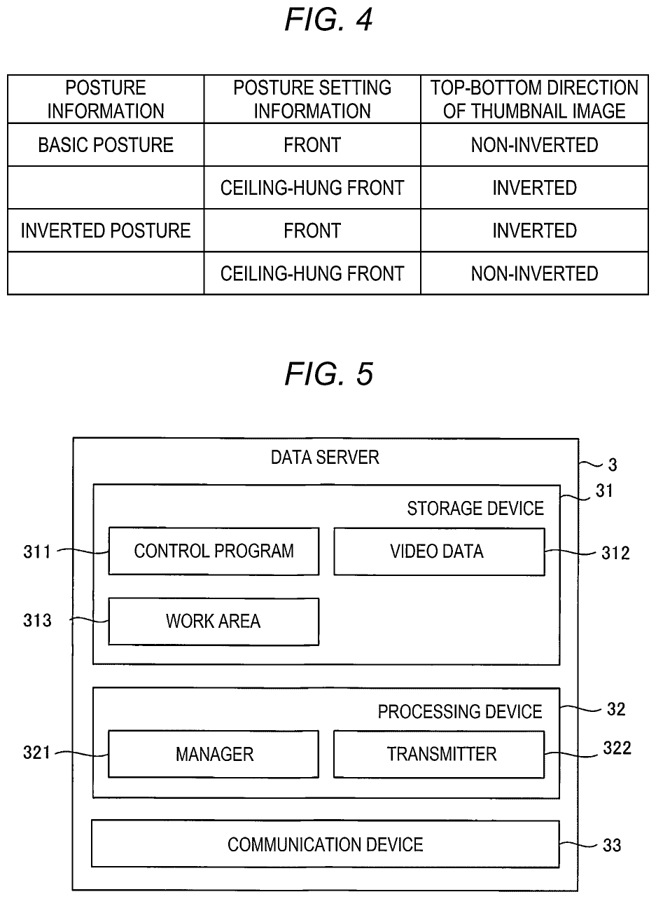

FIG. 4 shows the relationship between the posture information, the posture setting information, and the top-bottom direction of the thumbnail image. In FIG. 4, “front” indicates that the projector is disposed in front of the projection target and without the top-bottom direction inverted, as viewed from the position of a viewer viewing the projection image, as in this embodiment. “Ceiling-hung front” indicates that the projector is disposed in front of the projection target and with the top-bottom direction inverted, as viewed from the position of the viewer.

As shown in FIG. 4, when the posture information indicates the basic posture and the posture setting information indicates the front, the top-bottom direction of the thumbnail image is set to be non-inverted. “Non-inverted” indicates that the top-bottom direction of the first thumbnail image TI1 coincides with the top-bottom direction of the input image II1. When the posture information indicates the basic posture and the posture setting information indicates the ceiling-hung front, the top-bottom direction of the thumbnail image is set to be inverted. “Inverted” indicates that the top-bottom direction of the first thumbnail image TI1 is inverted in relation to the top-bottom direction of the input image II1. When the posture information indicates the inverted posture and the posture setting information indicates the front, the top-bottom direction of the first thumbnail image TI1 is set to be inverted. When the posture information indicates the inverted posture and the posture setting information indicates the ceiling-hung front, the top-bottom direction of the first thumbnail image TI1 is set to be non-inverted.

The reduced image acquirer 225 acquires a thumbnail image generated based on a projection image projected from the other projectors included in the multi-projection system, that is, the slave projectors, from the slave projectors. That is, the reduced image acquirer 225 acquires a second thumbnail image TI2 generated based on the second projection image PI2 projected in the second projection area PA2 from the second projector 2b. The reduced image acquirer 225 also acquires a third thumbnail image TI3 generated based on the third projection image PI3 projected in the third projection area PA3 from the third projector 2c.

The projection controller 226 in a first projection mode causes the projection device 25 to project the first projection image PI1 into the first projection area PA1. The first projection mode is a normal projection mode to perform multi-projection in the projection system 1.

The projection controller 226 in a second projection mode causes the projection device 25 to project the first thumbnail image TI1, the second thumbnail image TI2, and the third thumbnail image TI3 adjacently to each other in the first projection area PA1. The second projection mode is a mode to display an aggregate of the thumbnail images corresponding to the plurality of projectors, respectively, in one projection area, and thus allow the user U1 to check or change the settings of each projector participating in the multi-projection.

The switching between the first projection mode and the second projection mode is made by an operation on the operation device 24 by the user U1. The switching between the first projection mode and the second projection mode may also be made by an operation on the second projector 2b or the third projector 2c by the user U1.

The posture information acquirer 227 acquires posture information indicating the posture of the first projector 2a acquired by the posture detection device 26. The acquired posture information is used by the generator 224 to generate a reduced image.

The request acceptor 228 accepts various requests from the user U1 via the operation device 24. For example, the request acceptor 228 accepts a request about the settings of the multi-projection from the user U1. The settings of the multi-projection include the selection of a projector to participate in the multi-projection, the selection of an input image, the setting of a range cut out of the input image, the setting of luminance expansion, the setting of edge blending, and the like. For example, the request acceptor 228 accepts a switching request to switch between the first projection mode and the second projection mode from the user U1. The request acceptor 228 accepts a start request or an end request for the display of a thumbnail image from the user U1.

The setting changer 220 in the second projection mode changes at least one of the setting information of the first projector 2a, the setting information of the second projector 2b, and the setting information of the third projector 2c.

The information transmitter 229 transmits information such as request information and setting change information to the other projectors, that is, the second projector 2b and the third projector 2c. The request information is, for example, information that requests the generation and transmission of a thumbnail image and information that requests the transmission of the setting change information. The setting change information is, for example, information about the setting for the other projectors changed by the setting changer 220.

The communication device 23 is a piece of hardware as a transmitting and receiving device to communicate with another device. The communication device 23 is referred to as, for example, a network device, a network controller, a network card, a communication module, or the like. The communication device 23 may have a connector for wired connection and may have an interface circuit corresponding to the connector. The communication device 23 may also have a wireless communication interface. As the connector for wired connection and the interface circuit, a product conforming to wired LAN, IEEE 1394, USB, or the like can be employed. As the wireless communication interface, a product conforming to wireless LAN and Bluetooth (trademark registered) or the like can be employed. The communication device 23 performs data communication with an external device such as the second projector 2b, the third projector 2c, and the data server 3.

The operation device 24 is an input interface that accepts an input operation to the first projector 2a from the user U1. The operation device 24 has an operation button provided, for example, at the casing of the first projector 2a. The operation device 24 outputs information that identifies a pressed operation button to the processing device 22. Thus, the content of the input operation to the operation device 24 by the user U1 is outputted to the processing device 22. Thus, the content of the input operation to the operation device 24 by the user U1 is communicated to the processing device 22.

The operation device 24 may have a touch panel instead of the operation button. In this case, the operation device 24 outputs data indicating a detected touch position to the processing device 22. The operation device 24 may also be a remote control device that is separate from the casing of the first projector 2a.

The projection device 25 projects projection light. The projection device 25 has a light source, not illustrated, a light modulator 251, and a projection lens 252. The light source includes a halogen lamp, a xenon lamp, an ultra-high-pressure mercury lamp, an LED, a laser light source or the like. The light modulator 251 includes one or more liquid crystal panels. The light modulator 251 may include a DMD instead of the liquid crystal panel.

The light modulator 251 modulates light emitted from the light source into projection light to display the first projection image PI1 on the projection target 5, based on a signal inputted from the processing device 22. LED is an abbreviation for light-emitting diode. DMD is an abbreviation for digital mirror device. The projection lens 252 causes the projection light modulated by the light modulator 251 to form an image on the projection target 5.

The projection device 25 projects the projection light to display the first projection image PI1 onto the projection target 5 under the control of the projection controller 226. In other words, the projection device 25 projects an image based on image information inputted from the processing device 22, onto the projection target 5.

The posture detection device 26 detects which one of the basic posture and the inverted posture the posture of the first projector 2a is. Specifically, the posture detection device 26 is implemented by an acceleration sensor for one or more axes, a gyro sensor for one or more axes, or the like, and is fixed to the main body of the first projector 2a.

The configurations of the second projector 2b and the third projector 2c are similar to the configuration of the first projector 2a and therefore are not described further.

The second projection image PI2 is a second processed image formed by performing at least the processing of cutting a range to be projected into the second projection area PA2, out of the input image II1, in the second projector 2b. The third projection image PI3 is a third processed image formed by performing at least the processing of cutting a range to be projected into the third projection area PA3, out of the input image II1, in the third projector 2c.

### 1.3. Configuration of Data Server

The configuration of the data server 3 according to the first embodiment will now be described with reference to FIG. 5.

FIG. 5 is a block diagram showing an example of the configuration of the data server 3 shown in FIG. 1. The data server 3 has a storage device 31, a processing device 32, and a communication device 33.

The storage device 31 stores various information. The storage device 31 is configured, for example, including a volatile memory such as a RAM and a non-volatile memory such as a ROM. A control program 311, video data 312, and the like are stored in the storage device 31. The volatile memory of the storage device 31 is used by the processing device 32 as a work area 313 of the processing device 32. The control program 311 is a program that controls the entirety of the data server 3.

The processing device 32 controls the operations of the data server 3. The processing device 32 has functions as a manager 321 and a transmitter 322. The processing device 32 is configured, including one or more CPUs. However, the processing device 32 may have a programmable logic device such as an FPGA instead of or in addition to the CPU.

The processing device 32 reads out the control program 311 from the storage device 31 and executes the control program 311 thus read out. The processing device 32 executes the control program 311 and thus functions as the manager 321 and the transmitter 322.

The manager 321 manages the streaming schedule or the like of a plurality of video data 312. When the manager 321 has received a transmission request for specified video data from the first projector 2a, the manager 321 specifies the video data to be transmitted to the projection system 1 from among the plurality of video data 312. The manager 321 causes the transmitter 322 to transmit the specified video data to the projection system 1 in response to the transmission request from the first projector 2a.

The transmitter 322 transmits the specified video data from among the plurality of video data 312 to the projection system 1 via the communication device 33, based on an instruction from the manager 321.

The communication device 33 is a piece of hardware as a transmitting and receiving device to communicate with another device. The communication device 33 is referred to as, for example, a network device, a network controller, a network card, a communication module, or the like. The communication device 33 may have a connector for wired connection and may have an interface circuit corresponding to the connector. The communication device 33 may also have a wireless communication interface. As the connector for wired connection and the interface circuit, a product conforming to wired LAN, IEEE 1394, USB, or the like can be employed. As the wireless communication interface, a product conforming to wireless LAN and Bluetooth or the like can be employed. The communication device 33 performs data communication with an external device such as the first projector 2a, the second projector 2b, and the third projector 2c.

A part or the entirety of the storage device 31 may be provided in an external storage device, an external server, or the like. A part or all of the various information stored in the storage device 31 may be stored in the storage device 31 in advance or may be acquired from an external storage device, an external server, or the like.

### 1.4. Outline of Operations of Projection System

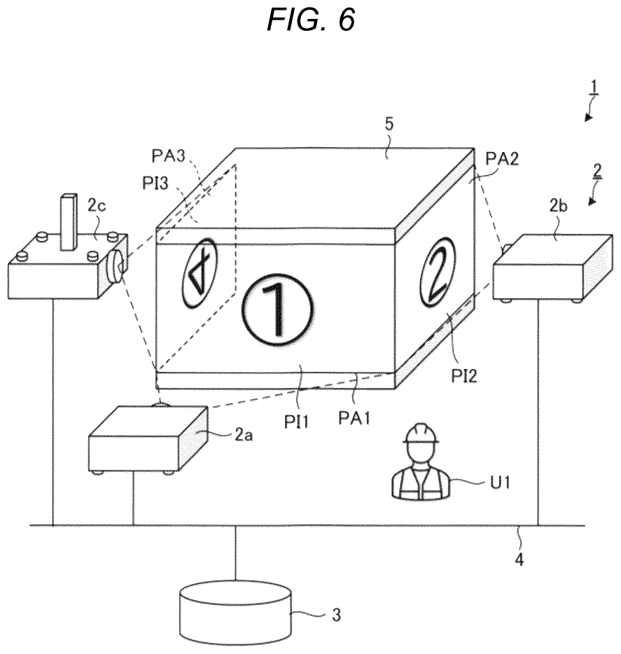

An outline of the operations of the projection system 1 will now be described with reference to FIGS. 6 to 9.

FIG. 6 shows an example of the operation of the projection system 1 in the first projection mode. As shown in FIG. 6, the first projector 2a projects the first projection image PI1 into the first projection area PA1. The image projected in the first projection area PA1 is an image corresponding to the first sub-image II1a. The second projector 2b projects the second projection image PI2 into the second projection area PA2. The image projected in the second projection area PA2 is an image corresponding to the second sub-image II1b.

The third projector 2c projects the third projection image PI3 into the third projection area PA3. According to the plan of the user U1, the image projected in the third projection area PA3 should be an image corresponding to the third sub-image II1c. However, in FIG. 6, an image corresponding to the fourth sub-image II1d is projected in the third projection area PA3. Also, in the third projection area PA3, an image formed by inverting the top and bottom of the fourth sub-image II1d is projected. Therefore, in the state shown in FIG. 6, a projection image that is different from the plan of the user U1 is projected in the third projection area PA3.

In this example, it is conceivable that the setting of the third projector 2c is not properly carried out. However, since the third projection area PA3 is a blind area to the user U1, it is hard for the user U1 to recognize that the image projected in the third projection area PA3 is an image that is different from the plan of the user U1.

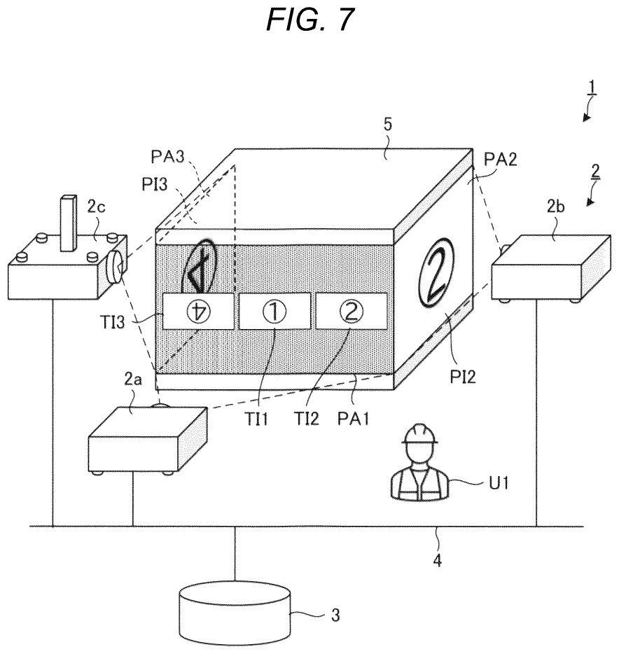

FIG. 7 shows an example of the operation of the projection system 1 in the second projection mode. As shown in FIG. 7, the first projector 2a projects the first thumbnail image TI1, the second thumbnail image TI2, and the third thumbnail image TI3 into the first projection area PA1. The first thumbnail image TI1 is an image corresponding to the first sub-image II1a. The second thumbnail image TI2 is an image corresponding to the second sub-image II1b. The third thumbnail image TI3 is an image corresponding to the fourth sub-image II1d and with the top and bottom inverted. The third thumbnail image TI3 is outputted as an image with the top and bottom inverted in relation to the input image II1, based on the posture information and the posture setting information of the third projector 2c.

According to the plan of the user U1, the third sub-image II1c should be projected in the “non-inverted” direction in the third projection area PA3. The user U1 can thus recognize that an image that is different from the image planned by the user U1 is projected in the direction opposite to the planned direction in the third projection area PA3 in the second projection mode.

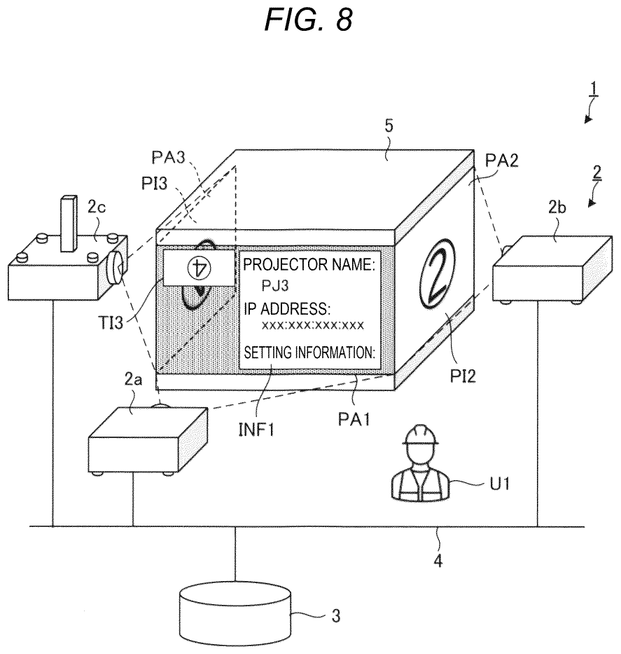

FIG. 8 shows an example of the operation of the projection system 1 in the second projection mode. In response to an operation of the operation device 24 by the user U1, the processing device 22 causes the various information set in the third projector 2c to be displayed in the first projection area PA1. More specifically, the information transmitter 229 transmits request information to request the setting information of the third projector 2c, to the third projector 2c. When the third projector 2c has received the request information from the information transmitter 229, the third projector 2c transmits the setting information of the third projector 2c to the first projector 2a.

The setting information acquirer 222 acquires the setting information of the third projector 2c. As shown in FIG. 8, the projection controller 226 projects the third thumbnail image TI3 and setting information INF1 of the third projector 2c into the first projection area PA1, based on the acquired setting information.

In the setting information INF1, a range to be cut out corresponding to the fourth sub-image II1d is set as the range to be cut out of the input image II1, and “front” is set as the installation posture.

The user U1 modifies the settings of the third projector 2c according to the plan of the user U1. In this case, the user U1 changes the range to be cut out of the input image II1 from the range to be cut out corresponding to the fourth sub-image II1d to a range to be cut out corresponding to the third sub-image II1c, by operating the operation device 24. The user U1 also changes the setting of the installation posture from “front” to “ceiling-hung front” by operating the operation device 24.

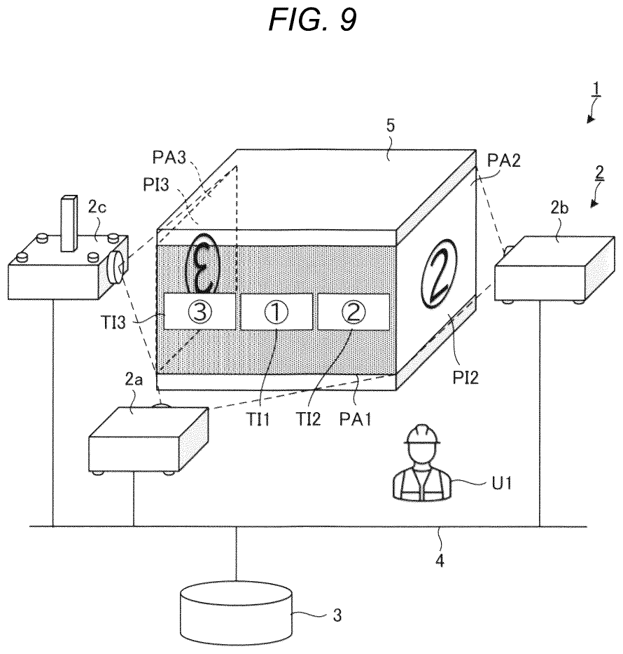

FIG. 9 shows an example of the operation of the projection system 1 in the second projection mode. The user U1 refers to the changed third thumbnail image TI3 and thus can confirm that the third projection image PI3 is correctly projected. As shown in FIG. 9, the arrangement of the first thumbnail image TI1, the second thumbnail image TI2, and the third thumbnail image TI3, and the arrangement of the first projection area PA1, the second projection area PA2, and the third projection area PA3 coincide with each other.

### 1.5. Example of Operation of Projection System

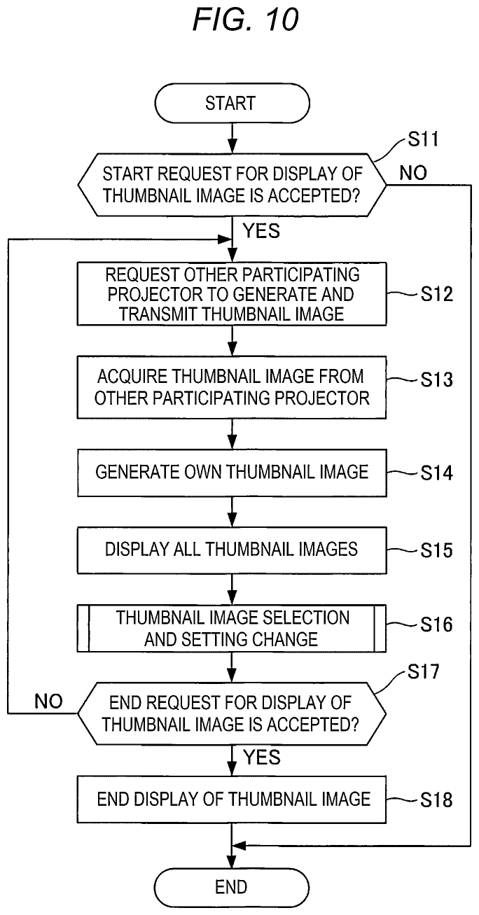

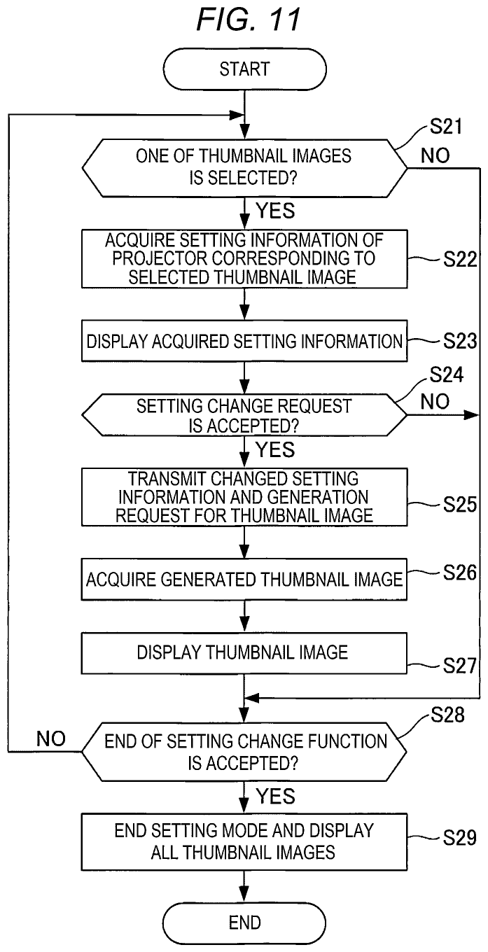

An example of the operation of the projection system 1 according to the first embodiment will now be described with reference to FIGS. 10 and 11.

FIG. 10 is a flowchart showing the operation of displaying a thumbnail image by the processing device 22 of the first t projector 2a. The operation of displaying a thumbnail image by the processing device 22 will now be described with reference to FIG. 10. The routine shown in FIG. 10 is, for example, configured to be started by the activation of the processing device 22 and executed every time a predetermined time period passes.

As the routine shown in FIG. 10 is started, first in step S11, the processing device 22 determines whether a start request for the display of a thumbnail image is accepted from the user U1 or not. In other words, in step S11, the processing device 22 determines whether a request to switch the projection mode from the first projection mode to the second projection is accepted from the user U1 or not.

When the processing device 22 has determined in step S11 that a start request for the display of a thumbnail image is accepted from the user U1, that is, when the result of the determination in step S11 is positive (YES in step S11), the processing device 22 executes the processing of step S12. In this case, in step S12, the processing device 22 requests the participating projector, that is, the second projector 2b and the third projector 2c, to generate and transmit a thumbnail image.

Meanwhile, when the processing device 22 has determined in step S11 that a start request for the display of a thumbnail image is not accepted from the user U1, that is, when the result of the determination in step S11 is negative (NO in step S11), the processing device 22 skips the processing of steps S12 to S18 and ends this routine for the moment. That is, in this case, the processing device 22 does not execute the display of a thumbnail image.

Next, in step S13, the processing device 22 acquires the second thumbnail image TI2 generated by the second projector 2b and the third thumbnail image TI3 generated by the third projector 2c.

In step S14, the processing device 22 generates the first thumbnail image TI1.

Next, in step S15, the processing device 22 projects the first thumbnail image TI1, the second thumbnail image TI2, and the third thumbnail image TI3 adjacently to each other in the first projection area PA1.

Next, in step S16, the processing device 22 executes processing of thumbnail image selection and setting change. The processing of thumbnail image selection and setting change is the processing for the user U1 to select a displayed thumbnail image and check and change the setting of the projector corresponding to the selected thumbnail image. Details of the processing of thumbnail image selection and setting change will be described later.

Next, in step S17, the processing device 22 determines whether an end request for the display of the thumbnail image is accepted from the user U1 or not. In other words, in step S17, the processing device 22 determines whether a request to switch the projection mode from the second projection mode to the first projection mode is accepted from the user U1 or not.

When the processing device 22 has determined in step S17 that an end request for the display of the thumbnail image is accepted from the user U1, that is, when the result of the determination in step S17 is positive (YES in step S17), the processing device 22 executes the processing of step S18. In this case, in step S18, the processing device 22 ends the display of the first thumbnail image TI1, the second thumbnail image TI2, and the third thumbnail image TI3, and then ends this routine for the moment.

Meanwhile, when the processing device 22 has determined in step S17 that an end request for the display of the thumbnail image is not accepted from the user U1, that is, when the result of the determination in step S17 is negative (NO in step S17), the processing device 22 executes the processing of step S12 again. That is, the processing device 22 continues displaying the first thumbnail image TI1, the second thumbnail image TI2, and the third thumbnail image TI3 until an end request for the display of the thumbnail image is accepted.

It is desirable that, when ending the display of the thumbnail image in step S18, the processing device 22 notifies the second projector 2b and the third projector 2c that the second projection mode is ended. Thus, the second projector 2b and the third projector 2c can stop the generation and transmission of the thumbnail image. Also, the second projector 2b and the third projector 2c may periodically transmit an acknowledgement to the first projector 2a, and may stop the generation and transmission of the thumbnail image when a response to the transmitted acknowledgement is not given.

The operation of displaying a thumbnail image by the processing device 22 according to the first embodiment is described above. In the foregoing steps, the processing device 22 functions as follows. In steps S11 and S17, the processing device 22 functions as the request acceptor 228. In step S12, the processing device 22 functions as the information transmitter 229. In step S13, the processing device 22 functions as the reduced image acquirer 225. In step S14, the processing device 22 functions as the generator 224. In steps S15 and S18, the processing device 22 functions as the projection controller 226.

FIG. 11 is a flowchart showing the operation of thumbnail image selection and setting change, which is a subroutine of FIG. 10. The operation of thumbnail image selection and setting change by the processing device 22 will now be described with reference to FIG. 11. The routine shown in FIG. 11 is executed after step S15, as shown in FIG. 10.

As the routine shown in FIG. 11 is started, first in step S21, the processing device 22 determines whether one of the first thumbnail image TI1, the second thumbnail image TI2, and the third thumbnail image TI3 is selected by the user U1 or not.

When the processing device 22 has determined in step S21 that one of the thumbnail images is selected, that is, when the result of the determination in step S21 is positive (YES in step S21), the processing device 22 executes the processing of step S22. In this case, in step S22, the processing device 22 acquires the setting information of the projector corresponding to the selected thumbnail image.

More specifically, the processing device 22 transmits, to the projector corresponding to the selected thumbnail image, a transmission request to transmit the setting information of the corresponding projector to the first projector 2a. When the corresponding projector has received the transmission request from the first projector 2a, the corresponding projector transmits the corresponding projector's own setting information to the first projector 2a. The processing device 22 acquires the setting information of the corresponding projector from information received by the communication device 23.

Next, in step S23, the processing device 22 displays the acquired setting information as a part of the first projection image PI1 in the first projection area PA1.

Next, in step S24, the processing device 22 determines whether a setting change request by the user U1 is accepted or not.

When the processing device 22 has determined in step S24 that a setting change request by the user U1 is accepted, that is, when the result of the determination in step S24 is positive (YES in step S24), the processing device 22 executes the processing of step S25. In this case, in step S25, the processing device 22 transmits the changed setting information and a generation request for a thumbnail image to the corresponding projector.

Next, in step S26, the processing device 22 acquires a thumbnail image generated by the corresponding projector.

Next, in step S27, the processing device 22 displays the acquired thumbnail image. The thumbnail image displayed at this point reflects the result of the setting change in step S25.

Next, in step S28, the processing device 22 determines whether an end of the setting change function is accepted from the user U1 or not.

When the processing device 22 has determined in step S28 that an end of the setting change function is accepted from the user U1, that is, when the result of the determination in step S28 is positive (YES in step S28), the processing device 22 executes the processing of step S29. In this case, in step S29, the processing device 22 ends the setting change function, displays all the thumbnail images, that is, the first thumbnail image TI1, the second thumbnail image TI2, and the third thumbnail image TI3, and ends this routine.

Meanwhile, when the processing device 22 has determined in step S28 that an end of the setting change function is not accepted from the user U1, that is, when the result of the determination in step S28 is negative (NO in step S28), the processing device 22 executes the processing of step S21 again.

Meanwhile, when the processing device 22 has determined in step S24 that a setting change request by the user U1 is not accepted, that is, when the result of the determination in step S24 is negative (NO in step S24), the processing device 22 skips the processing of steps S25 to S27 and executes the processing of step S28.

When the processing device 22 has determined in step S21 that one of the thumbnail images is not selected, that is, when the result of the determination in step S21 is negative (NO in step S21), the processing device 22 skips the processing of steps S22 to S27 and executes the processing of step S28.

The operation of thumbnail image selection and setting change by the processing device 22 according to the first embodiment is described above. In steps S21 and S28, the processing device 22 functions as the request acceptor 228. In step S22, the processing device 22 functions as the setting information acquirer 222. In steps S23, S27, and S29, the processing device 22 functions as the projection controller 226. In step S24, the processing device 22 functions as the request acceptor 228 and the setting changer 220. In step S25, the processing device 22 functions as the information transmitter 229. In step S26, the processing device 22 functions as the reduced image acquirer 225.

### 1.6. Effects Achieved by First Embodiment

As described above, the projection method according to the first embodiment is a projection method in the multi-projection system including the first projector 2a, the second projector 2b, and the third projector 2c.

In this method, in the first projection mode, the first projection image PI1 is projected into the first projection area PA1 from the first projector 2a. The second projection image PI2 is projected into the second projection area PA2 from the second projector 2b. The third projection image PI3 is projected into the third projection area PA3 from the third projector 2c. The first projection image PI1, the second projection image PI2, and the third projection image PI3 are based on the input image II1 inputted to the first projector 2a, the second projector 2b, and the third projector 2c.

In this method, in the second projection mode, the first thumbnail image TI1, the second thumbnail image TI2, and the third thumbnail image TI3 are projected adjacently to each other into the first projection area PA1 from the first projector 2a.

The first thumbnail image TI1 is a reduced image of the first projection image PI1. The second thumbnail image TI2 is a reduced image of the second projection image PI2. The third thumbnail image TI3 is a reduced image of the third projection image PI3.

According to this method, the first thumbnail image TI1, the second thumbnail image TI2, and the third thumbnail image TI3 are projected adjacently to each other in the first projection area PA1. Thus, the user U1 can simultaneously view the first thumbnail image TI1, the second thumbnail image TI2, and the third thumbnail image TI3. Therefore, even when the user U1 cannot view the third projection image PI3 from the position of the user U1, the user U1 can check, on the spot, whether the third projection image PI3 is an image as intended or not. In this way, this method can improve the work efficiency of the user U1 constructing the multi-projection system.

In the first embodiment, the first thumbnail image TI1 is an example of a “first reduced image”. The second thumbnail image TI2 is an example of a “second reduced image”. The processing device 22 is an example of a “processor”. The projection device 25 is an example of a “first projection mechanism”.

The switching between the first projection mode and the second projection mode is made by an operation to the first projector 2a by the user U1.

Thus, the user U1 can operate the first projector 2a to switch the projection mode of the first projector 2a from the first projection mode to the second projection mode. The user U1 can thus cause the first projector 2a to display a thumbnail image corresponding to each projector and can easily check the setting of each projector.

The first projection image PI1 is the first processed image formed by performing at least the processing of cutting a range to be projected into the first projection area PA1, out of the input image II1, in the first projector 2a. The second projection image PI2 is the second processed image formed by performing at least the processing of cutting a range to be projected into the second projection area PA2, out of the input image II1, in the second projector 2b.

Thus, a processed image that is cut out of the input image, that is, an image more similar to a projection image to be actually projected, can be outputted as a thumbnail image. Therefore, the user U1 can more easily check whether the third projection image PI3 is an image as intended or not.

The arrangement of the first thumbnail image TI1, the second thumbnail image TI2, and the third thumbnail image TI3, and the arrangement of the first projection area PA1, the second projection area PA2, and the third projection area PA3 coincide with each other.

Thus, the user U1 can observe the status of the first projection image PI1, the second projection image PI2, and the third projection image PI3, as thumbnail images, based on the arrangement coincident with the arrangement in which these projection images are actually projected. Therefore, the user U1 can grasp the status more accurately.

In this method, the top-bottom direction of the third thumbnail image TI3 is determined, based on the posture information and the posture setting information. The posture information is information indicating which of the basic posture and the inverted posture with the top and bottom inverted in relation to the basic posture is employed as the posture of the third projector 2c. The posture setting information is information indicating which direction the top-bottom direction of the third projection image PI3 in the third projector 2c is set to.

Thus, the top-bottom direction of the third thumbnail image TI3 reflects the posture of the third projector 2c and also reflects the posture setting by the user U1. Therefore, the top-bottom direction of the third thumbnail image TI3 and the top-bottom direction of the third projection image PI3 projected into the third projection area PA3 coincide with each other. The user U1 can more accurately grasp the status.

The projection system 1 according to the first embodiment includes the first projector 2a, the second projector 2b, and the third projector 2c. The projection system 1 is a projection system to perform multi-projection by the first projector 2a, the second projector 2b, and the third projector 2c.

In the first projection mode, the first projector 2a projects the first projection image PI1 into the first projection area PA1. In the first projection mode, the second projector 2b projects the second projection image PI2 into the second projection area PA2. In the first projection mode, the third projector 2c projects the third projection image PI3 into the third projection area PA3.

In the second projection mode, the first projector 2a projects the first thumbnail image TI1 formed by reducing the first projection image PI1, the second thumbnail image TI2 formed by reducing the second projection image PI2, and the third thumbnail image TI3 formed by reducing the third projection image PI3, adjacently to each other in the first projection area PA1.

Thus, the user U1 can simultaneously view the first thumbnail image TI1, the second thumbnail image TI2, and the third thumbnail image TI3. Therefore, even when the user U1 cannot view the third projection image PI3 from the position of the user U1, the user U1 can check, on the spot, whether the third projection image PI3 is an image as intended or not. In this way, the projection system 1 can improve the work efficiency of the user U1 constructing the multi-projection system.

The first projector 2a according to the first embodiment is a projector included in a multi-projection system and having the projection device 25. The first projector 2a has the processing device 22. The processing device 22 has the input image acquirer 221, the setting information acquirer 222, the image processor 223, the generator 224, the reduced image acquirer 225, and the projection controller 226.

The input image acquirer 221 acquires the input image II1. The setting information acquirer 222 acquires the setting information. The setting information is information that designates a content of image processing including at least cutting an image in a range to be projected into the first projection area PA1, out of the input image II1. The image processor 223 performs the image processing represented by the setting information to the input image II1 and thus outputs the first projection image PI1. The generator 224 generates the first thumbnail image TI1 formed by reducing the first projection image PI1, from the first projection image PI1.

The reduced image acquirer 225 acquires the second thumbnail image TI2 and the third thumbnail image TI3. The second thumbnail image TI2 is an image generated based on the second projection image PI2 to be projected into the second projection area PA2, in the second projector 2b included in the multi-projection system. The third thumbnail image TI3 is an image generated based on the third projection image PI3 to be projected into the third projection area PA3, in the third projector 2c included in the multi-projection system.

The projection controller 226 in the first projection mode causes the projection device 25 to project the first projection image PI1 into the first projection area PA1. The projection controller 226 in the second projection mode causes the projection device 25 to project the first thumbnail image TI1, the second thumbnail image TI2, and the third thumbnail image TI3 adjacently to each other in the first projection area PA1.

Thus, even when the user U1 cannot view the third projection image PI3 from the position of the user U1, the user U1 can simultaneously view the first thumbnail image TI1, the second thumbnail image TI2, and the third thumbnail image TI3. Therefore, the user U1 can check, on the spot, whether the third projection image PI3 is an image as intended or not, without having to move to a position where the user U1 can view the third projection image PI3. In this way, this projector can improve the work efficiency of the user U1 constructing the multi-projection system.

The first projector 2a also has the setting changer 220. The setting changer 220 in the second projection mode changes at least one of the setting information of the first projector 2a, the setting information of the second projector 2b, and the setting information of the third projector 2c.

The setting information of the second projector 2b is information that designates a content of image processing including at least cutting a range to be projected into the second projection area PA2, out of the input image II1 inputted to the second projector 2b. The setting information of the third projector 2c is information that designates a content of image processing including at least cutting a range to be projected into the third projection area PA3, out of the input image II1 inputted to the third projector 2c.

Thus, when there is a problem in the settings of the first to third projectors 2a to 2c, the user U1 can change at least one of the settings of the first to third projectors 2a to 2c on the spot. Therefore, this projector can further improve the work efficiency of the user U1 constructing the multi-projection system.

### 2. MODIFICATION EXAMPLES

The present disclosure is not limited to the above embodiment. Various modification examples can be employed within the scope of the present disclosure. Examples of specific modification aspects will be given below. Two or more aspects arbitrarily selected from the examples given below can be combined together according to need without contradiction to each other. In the modification examples given below, an element having an action or function equivalent to an action or function described in the forgoing embodiment is designated by a reference sign used in the foregoing description and the detailed description of each such element is omitted where appropriate.

### 2.1. Modification Example 1

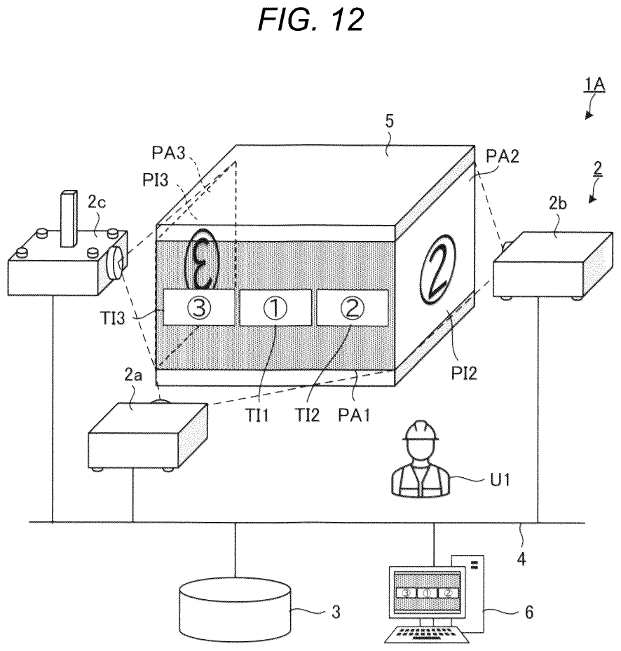

The projection system may include an information processing device. FIG. 12 shows the configuration of a projection system 1A according to Modification Example 1. The projection system 1A includes a plurality of projectors 2, a data server 3, and an information processing device 6. The plurality of projectors 2, the data server 3, and the information processing device 6 are connected to each other via a network 4.

The configuration of the projection system 1A according to this modification example differs from the configuration of the projection system 1 according to the first embodiment in that the projection system 1A includes the information processing device 6.

When the first projector 2a functions as the master projector, the information processing device 6 executes a part of the functions of the first projector 2a.

For example, the information processing device 6 can switch the projection mode of the first projector 2a between the first projection mode and the second projection mode in response to an operation by the user U1. When switching the projection mode from the first projection mode to the second projection mode, the information processing device 6 transmits request information that requests the generation and transmission of a thumbnail image, to the second projector 2b and the third projector 2c.

The information processing device 6 can also select one of the first thumbnail image TI1, the second thumbnail image TI2, and the third thumbnail image TI3 in the second projection mode in response to an operation by the user U1. Thus, the information processing device 6 notifies the projector corresponding to the thumbnail image concerned, of a request to transmit the setting information of the projector.

The information processing device 6 also displays the setting information of the projector corresponding to the thumbnail image concerned, in the first projection area PA1 or on the display of the information processing device 6. The information processing device 6 can change the setting information of the projector corresponding to the thumbnail image concerned, in response to an operation by the user U1.

### 2.2. Modification Example 2

The image processing may include edge blending. Edge blending is the processing of causing two neighboring projection images to partly overlap each other in such a way that the seam between the two neighboring projection images is hard to recognize, and reducing light in each of the projection images at the part where the two neighboring projection images overlap each other. For example, when the projection target 5 is not a pillar-like structure as described in the first embodiment but is a planar surface or an almost planar structure having the first projection area PA1, the second projection area PA2, and the third projection area PA3, it is preferable that edge blending is performed to the two neighboring projection images.

In the first processed image, edge blending is performed to an image formed by cutting a range to be projected into the first projection area PA1, out of the input image II1. In the second processed image, edge blending is performed to an image formed by cutting a range to be projected into the second projection area PA2, out of the input image II1. In the third processed image, edge blending is performed to an image formed by cutting a range to be projected into the third projection area PA3, out of the input image II1.

In this case, each thumbnail image reflects the result of the edge blending. When two neighboring projection images are projected overlapping each other to the projection target, the thumbnail images corresponding to the two neighboring projection images may be displayed overlapping each other similarly to the actually projected projection images. The two neighboring thumbnail images may be displayed, spaced apart from each other. Thus, the status of the edge blending can be easily grasped.

### 2.3. Modification Example 3

In the first embodiment, each thumbnail image is generated based on the input image II1, by the generator 224. However, each thumbnail image may be generated based on an image of the projection image projected in each projection area that is captured using a camera.

In the method according to this modification example, first, an image of the first projection area PA1 where the first projection image PI1 is projected in the first projection mode is captured, using a first camera, and a first captured image is thus acquired. Similarly, an image of the second projection area PA2 where the second projection image PI2 is projected in the first projection mode is captured, using a second camera, and a second captured image is thus acquired. An image of the third projection area PA3 where the third projection image PI3 is projected in the first projection mode is captured, using a third camera, and a third captured image is thus acquired.

The first thumbnail image is the first captured image, which is a captured image of the first projection area PA1 where the first projection image PI1 is projected. The second thumbnail image is the second captured image, which is a captured image of the second projection area PA2 where the second projection image PI2 is projected. The third thumbnail image is the third captured image, which is a captured image of the third projection area PA3 where the third projection image PI3 is projected.

Next, in the second projection mode, the first captured image, the second captured image, and the third captured image are projected adjacently to each other into the first projection area PA1 from the first projector 2a. Thus, the status of the third projection image PI3 that is actually projected can be observed as a thumbnail image. Therefore, the user U1 can grasp the status more accurately. At least one of the first captured image, the second captured image, and the third captured image may be reduced or may be not reduced before being projected as a thumbnail image. The first projection image PI1 included in the first captured image may appear in a smaller size, for example, depending on the distance from the first camera to the first projection area PA1. In such a case, the first captured image suitable as a thumbnail image is acquired even when the first captured image is not reduced.

### 2.4. Modification Example 4

In the first embodiment, each thumbnail image is an output image from each projector. However, each thumbnail image may be a reduced image of the input image II1. In this case, the generator 224 generates each thumbnail image from the input image II1.

For example, a case where an abnormality is observed in the second thumbnail image TI2 when the first projector 2a in the second projection mode projects a reduced image of the first projection image as the first thumbnail image TI1, projects a reduced image of the second projection image as the second thumbnail image TI2, and projects a reduced image of the third projection image as the third thumbnail image TI3 into the first projection area PA1, will now be considered.

In this case, the user U1 can cause the first projector 2a to project an image formed by reducing the input image II1 in the first projector 2a as the first thumbnail image TI1, project an image formed by reducing the input image II1 in the second projector 2b as the second thumbnail image TI2, and project an image formed by reducing the input image II1 in the third projector 2c as the third thumbnail image TI3.

In other words, the first thumbnail image TI1 is a reduced image of the input image II1 inputted to the first projector 2a. The second thumbnail image TI2 is a reduced image of the input image II1 inputted to the second projector 2b. The third thumbnail image TI3 is a reduced image of the input image II1 inputted to the third projector 2c.

Thus, the entirety of the input image II1 used for multi-projection is projected into the first projection area PA1. Therefore, the user U1 can easily check whether there is a problem in the input image II1 inputted to each projector or not. The user U1 may project only the second thumbnail image TI2 without projecting the first thumbnail image TI1 and the third thumbnail image TI3.

### 2.5. Modification Example 5

The projection system 1 according to the first embodiment and the projection system 1A according to Modification Example 1 include the data server 3. However, the data server 3 is not necessarily needed. In such a case, in the projection system 1, one projector of the plurality of projectors 2 may also serve as a data server. In the projection system 1A, one projector of the plurality of projectors 2 or the information processing device 6 may also serve as a data server.

### 2.6. Modification Example 6

In the projection system 1 according to the first embodiment and the projection system 1A according to Modification Example 1, the setting information of the first projector 2a, the setting information of the second projector 2b, and the setting information of the third projector 2c may include information about the arrangement of the plurality of projectors 2 included in the multi-projection system. Thus, the first thumbnail image TI1, the second thumbnail image TI2, and the third thumbnail image TI3 can be correctly arranged, based on the information about the arrangement.

### 2.7. Modification Example 7

In the projection system 1 according to the first embodiment and the projection system 1A according to Modification Example 1, the thumbnail images corresponding to all the projectors participating in multi-projection are displayed in the first projection area PA1. However, only a thumbnail image corresponding to one or more projectors arbitrarily selected by the user U1 may be displayed. For example, the user U1 may select only the third thumbnail image TI3 corresponding to the third projection image PI3, which the user U1 cannot view, and thus may cause the third thumbnail image TI3 to be displayed in the first projection area PA1. Alternatively, the user U1 may cause the third thumbnail image TI3 and the first thumbnail image TI1, which is next to the third thumbnail image TI3, to be displayed adjacently to each other.

### 2.8. Modification Example 8

In the projection system 1 according to the first embodiment and the projection system 1A according to Modification Example 1, an acceleration sensor, a gyro sensor or the like is used for the posture detection device 26. However, the posture detection device is not limited to this. For example, the posture detection device may be a device that is disposed in the projector and that has a moving body moving with gravity and a detector detecting the position of the moving body. The posture detection device may also be a device that is disposed outside the projector and that has a camera configured to be able to capture an image of the projector and a determiner determining the direction of the projector, based on the image captured by the camera.

### 2.9. Modification Example 9

The posture detection device 26 is not necessarily needed. The user U1 may set posture information for the projector, using the operation device 24.

### 3. SUPPLEMENTARY NOTES

An overall summary of the present disclosure is given below in the form of supplementary notes.

### 3.1. Supplementary Note 1

A projection method in a multi-projection system including a first projector and a second projector is provided. The projection method includes: in a first projection mode, projecting a first projection image based on an input image inputted to the first projector and the second projector, from the first projector into a first projection area, and projecting a second projection image based on the input image from the second projector into a second projection area; and in a second projection mode, projecting a first reduced image and a second reduced image adjacently to each other from the first projector into the first projection area. The first reduced image is a reduced image of the first projection image. The second reduced image is a reduced image of the second projection image.

In the projection method according to Supplementary Note 1, the reduced image of the first projection image and the reduced image of the second projection image are projected adjacently to each other in the first projection area. Thus, the user can simultaneously view the reduced image of the first projection image and the reduced image of the second projection image. Therefore, even when the user cannot view the second projection image from the position of the user, the user can check, on the spot, whether the second projection image is an image as intended or not.

### 3.2. Supplementary Note 2

A projection method in a multi-projection system including a first projector and a second projector is provided. The projection method includes: in a first projection mode, projecting a first projection image based on an input image inputted to the first projector and the second projector, from the first projector into a first projection area, and projecting a second projection image based on the input image from the second projector into a second projection area; and in a second projection mode, projecting at least one of a first reduced image and a second reduced image from the first projector into the first projection area. The first reduced image is a reduced image of the input image inputted to the first projector. The second reduced image is a reduced image of the input image inputted to the second projector.

In the projection method according to Supplementary Note 2, at least one of the reduced image of the input image inputted to the first projector and the reduced image of the input image inputted to the second projector can be projected into the first projection area. Thus, the user can easily check whether there is a problem in the input image inputted to the first projector or the input image inputted to the second projector, or not. In this way, the projection method according to Supplementary Note 2 can improve the work efficiency of the user constructing the multi-projection system.

### 3.3. Supplementary Note 3

In the projection method according to Supplementary Note 1 or Supplementary Note 2, a switching between the first projection mode and the second projection mode is made by an operation to one of the first projector and the second projector by a user.

In the projection method according to Supplementary Note 3, the user can operate the first projector or the second projector to switch the projection mode of the operated projector from the first projection mode to the second projection mode. The user can thus cause one of the first projector and the second projector to display the reduced image similarly to the other projector and therefore can easily check the setting of each projector.

### 3.4. Supplementary Note 4

In the projection method according to Supplementary Note 1, the first projection image is a first processed image formed by performing at least processing of cutting a range to be projected into the first projection area, out of the input image. The second projection image is a second processed image formed by performing at least processing of cutting a range to be projected into the second projection area, out of the input image.

In the projection method according to Supplementary Note 4, a processed image that is cut out of the input image, that is, an image more similar to the projection image to be actually projected, can be outputted as a reduced image. Therefore, the user can more easily check whether the second projection image is an image as intended or not.

### 3.5. Supplementary Note 5

In the projection method according to Supplementary Note 4, in the first processed image, edge blending is performed to an image formed by cutting a range to be projected into the first projection area, out of the input image. In the second processed image, edge blending is performed to an image formed by cutting a range to be projected into the second projection area, out of the input image.

With the projection method according to Supplementary Note 5, the status of the edge blending can be easily grasped.

### 3.6. Supplementary Note 6

A projection method in a multi-projection system including a first projector and a second projector is provided. The projection method includes: in a first projection mode, projecting a first projection image from the first projector into a first projection area, and projecting a second projection image from the second projector into a second projection area; and in a second projection mode, projecting a first reduced image and a second reduced image adjacently to each other from the first projector into the first projection area. The first reduced image is a first captured image formed by picking up an image of the first projection area where the first projection image is projected. The second reduced image is a second captured image formed by picking up an image of the second projection area where the second projection image is projected.

In the projection method according to Supplementary Note 6, the status of the second projection image that is actually projected can be observed as a reduced image. Therefore, the status can be grasped more accurately.

### 3.7. Supplementary Note 7

In the projection method according to one of Supplementary Notes 1 to 6, an arrangement of the first reduced image and the second reduced image, and an arrangement of the first projection area and the second projection area coincide with each other.

In the projection method according to Supplementary Note 7, the status of the first projection image and the second projection image can be observed as reduced images, based on the arrangement coincident with the arrangement in which these projection images are actually projected. Therefore, the status can be grasped more accurately.

### 3.8. Supplementary Note 8

In the projection method according to one of Supplementary Notes 1 to 7, a top-bottom direction of the second reduced image is determined, based on posture information indicating which of a basic posture and an inverted posture with top and bottom inverted in relation to the basic posture is employed as a posture of the second projector, and posture setting information indicating which direction a top-bottom direction of the second projection image in the second projector is set to.

In the projection method according to Supplementary Note 8, the top-bottom direction of the second reduced image reflects the posture of the second projector and also reflects the posture setting by the user. Therefore, the top-bottom direction of the second reduced image and the top-bottom direction of the second projection image projected into the second projection area coincide with each other. The user can more accurately grasp the status.

### 3.9. Supplementary Note 9

A projection system including a first projector and a second projector and performing multi-projection by the first projector and the second projector is provided. In a first projection mode, the first projector projects a first projection image into a first projection area. In the first projection mode, the second projector projects a second projection image into a second projection area. In a second projection mode, the first projector projects a first reduced image formed by reducing the first projection image and a second reduced image formed by reducing the second projection image, adjacently to each other in the first projection area.

With the projection system according to Supplementary Note 9, the user can simultaneously view the first reduced image and the second reduce image. Therefore, even when the user cannot view the second projection image from the position of the user, the user can check, on the spot, whether the second projection image is an image as intended or not. In this way, the projection system according to Supplementary Note 9 can improve the work efficiency of the user constructing the multi-projection system.

### 3.10. Supplementary Note 10

A projector included in a multi-projection system and having a first projection mechanism is provided. The projector includes one or a plurality of processors. The one or plurality of processors are configured to: acquire an input image; acquire setting information that designates a content of image processing including at least cutting an image in a range to be projected into a first projection area, out of the input image; perform the image processing represented by the setting information to the input image and thus output a first projection image; generate a first reduced image formed by reducing the input image or the first projection image, from the input image or the first projection image; acquire a second reduced image generated based on a second projection image projected in a second projection area by another projector included in the multi-projection system; and in a first projection mode, cause the first projection mechanism to project the first projection image into the first projection area, and in a second projection mode, cause the first projection mechanism to project the first reduced image and the second reduced image adjacently to each other in the first projection area.

With the projector according to Supplementary Note 10, even when the user cannot view the second projection image from the position of the user, the user can simultaneously view the first reduced image and the second reduced image. Therefore, the use can check, on the spot, whether the second projection image is an image as intended or not, without having to move to a position where the user can view the second projection image. In this way, the projector according to Supplementary Note 10 can improve the work efficiency of the user constructing the multi-projection system.

### 3.11. Supplementary Note 11

The projector according to Supplementary Note 10 further includes a setting changer that changes, in the second projection mode, at least one of the setting information and another setting information that designates a content of image processing including at least cutting a range to be projected into the second projection area, out of another input image inputted to the another projector.

With the projector according to Supplementary Note 11, when there is a problem in the settings of the first projector and the second projector, the user can change at least one of the settings of the first projector and the second projector on the spot. Therefore, the projector according to Supplementary Note 11 can further improve the work efficiency of the user constructing the multi-projection system.

### 3.12. Supplementary Note 12

In the projector according to Supplementary Note 10 or 11, the setting information and the another setting information include information about an arrangement of a plurality of projectors included in the multi-projection system.

With the projector according to Supplementary Note 12, the first reduced image and the second reduced image can be correctly arranged, based on the information about the arrangement.

What is claimed is:

1. A projection method in a multi-projection system including a first projector and a second projector, the projection method comprising:
in a first projection mode, projecting a first projection image based on an input image inputted to the first projector and the second projector, from the first projector into a first projection area, and projecting a second projection image based on the input image from the second projector into a second projection area; and
in a second projection mode, projecting a first reduced image and a second reduced image adjacently to each other from the first projector into the first projection area,
the first reduced image being a reduced image of the first projection image,
the second reduced image being a reduced image of the second projection image.

2. A projection method in a multi-projection system including a first projector and a second projector, the projection method comprising:
in a first projection mode, projecting a first projection image based on an input image inputted to the first projector and the second projector, from the first projector into a first projection area, and projecting a second projection image based on the input image from the second projector into a second projection area; and
in a second projection mode, projecting at least one of a first reduced image and a second reduced image from the first projector into the first projection area,
the first reduced image being a reduced image of the input image inputted to the first projector,
the second reduced image being a reduced image of the input image inputted to the second projector.

3. The projection method according to claim 1, wherein
a switching between the first projection mode and the second projection mode is made by an operation to one of the first projector and the second projector by a user.

4. The projection method according to claim 1, wherein
the first projection image is a first processed image formed by performing at least processing of cutting a range to be projected into the first projection area, out of the input image inputted to the first projector, and
the second projection image is a second processed image formed by performing at least processing of cutting a range to be projected into the second projection area, out of the input image inputted to the second projector.

5. The projection method according to claim 4, wherein
in the first processed image, edge blending is performed to an image formed by cutting a range to be projected into the first projection area, out of the input image, and
in the second processed image, edge blending is performed to an image formed by cutting a range to be projected into the second projection area, out of the input image.

6. A projection method in a multi-projection system including a first projector and a second projector, the projection method comprising:
in a first projection mode, projecting a first projection image from the first projector into a first projection area, and projecting a second projection image from the second projector into a second projection area; and
in a second projection mode, projecting a first reduced image and a second reduced image adjacently to each other from the first projector into the first projection area,
the first reduced image being a first captured image formed by picking up an image of the first projection area where the first projection image is projected, and the second reduced image being a second captured image formed by picking up an image of the second projection area where the second projection image is projected.

7. The projection method according to claim 1, wherein
an arrangement of the first reduced image and the second reduced image, and an arrangement of the first projection area and the second projection area coincide with each other.

8. The projection method according to claim 1, wherein
a top-bottom direction of the second reduced image is determined, based on posture information indicating which of a basic posture and an inverted posture with top and bottom inverted in relation to the basic posture is employed as a posture of the second projector, and posture setting information indicating which direction a top-bottom direction of the second projection image in the second projector is set to.

9. A projection system comprising a first projector and a second projector and performing multi-projection by the first projector and the second projector, wherein
in a first projection mode, the first projector projects a first projection image into a first projection area, and in the first projection mode, the second projector projects a second projection image into a second projection area, and
in a second projection mode, the first projector projects a first reduced image formed by reducing the first projection image and a second reduced image formed by reducing the second projection image, adjacently to each other in the first projection area.

10. A projector included in a multi-projection system and comprising one or a plurality of processors,
the one or plurality of processors being configured to:
acquire an input image;
acquire setting information that designates a content of image processing including at least cutting an image in a range to be projected into a first projection area, out of the input image;
perform the image processing represented by the setting information to the input image and thus output a first projection image;
generate a first reduced image formed by reducing the input image or the first projection image, from the input image or the first projection image; and
acquire a second reduced image generated based on a second projection image projected in a second projection area by another projector included in the multi-projection system, wherein
the projector is configured to perform:
in a first projection mode, projecting the first projection image into the first projection area; and
in a second projection mode, projecting the first reduced image and the second reduced image adjacently to each other in the first projection area.

11. The projector according to claim 10, further comprising:
a setting changer that changes, in the second projection mode, at least one of the setting information and another setting information that designates a content of image processing including at least cutting a range to be projected into the second projection area, out of another input image inputted to the another projector.

12. The projector according to claim 11, wherein
the setting information and the another setting information include information about an arrangement of a plurality of projectors forming the multi-projection system.
